(19) United States
(12) Patent Application Publication
(10) Pub. No.: US 2005/0253372 A1
(43) Pub. Date: Nov. 17, 2005

(54) Combination memo pad and prescription script with complimentary sample means

(76) Inventor: Joshua Lapsker, Christ Church (BB)

Correspondence Address: KLAUBER & JACKSON, 411 HACKENSACK AVENUE, HACKENSACK, NJ, 07601, US

(21) Appl. No.: 10/865,500

(22) Filed: Jun. 10, 2004

Related U.S. Application Data
(63) Continuation-in-part of application No. 10/842,835, filed on May 11, 2004.

(51) Int. Cl. B42D 1/00

(52) U.S. Cl. 281/38

(57) ABSTRACT

A combination preprinted memo pad and preprinted prescription script assembly with complimentary sample means that facilitates distribution of prescription pharmaceuticals to patients.

### RELATED APPLICATION

This application is a Continuation-in-Part of co-pending application Ser. No. 10/842,835, filed May 11, 2004, and the entire disclosure of all applications are included herein in their entirety.

### BACKGROUND OF THE INVENTION

1. Field of the Invention

The present invention relates to a combination prescription script and memo pad for physicians that is preprinted, and aids in the dispensing of prescription pharmaceuticals.

2. Description of the Related Art

Certain pharmaceuticals are only available to patients with a written prescription from a physician. Typically, the physician writes out a prescription (sometimes known as an “Rx”), for an appropriate medication for a patient, which the patient then takes to a pharmacist who dispenses the medication in accordance with the handwritten prescription. During the visit to the doctor's office, the patient also usually receives a sample of the prescription to be filled.

The current approach to providing complimentary pharmaceuticals can be somewhat problematic. From a drug control standpoint, samples may be lost or stolen at a doctor's office. In terms of safety, samples may become old or expired. Other times, it may be inconvenient for physicians to use samples in their daily practice because of storage space and temperature requirements, or because it is a hassle to retrieve the samples in the course of a hectic day.

### SUMMARY OF THE INVENTION

It is therefore an object of the present invention to provide a system for enabling the convenient dispensing of sample drugs at the time of the actual writing of a prescription medication by a physician, without the need to retrieve stored samples or separate coupons.

Additional objects, advantages and other novel features of the invention will be set forth in part in the description that follows and in part will become apparent to those skilled in the art upon examination of the following or may be learned with the practice of the invention.

### BRIEF DESCRIPTION OF THE DRAWINGS

The accompanying drawings which are incorporated in, and constitute a part of the specification, illustrate a preferred embodiment of the invention and, together with the general description given above, and the detailed description of the preferred embodiment given below, serve to explain the principles of the invention.

FIG. 1 is an offset view of inventive combination prescription scripts and physician pad with the complimentary prescription sample means included therein in an opened position;

FIG. 2 is an offset view of the inventive combination prescription scripts and memo pad with the complimentary prescription sample means included therein in an opened position, showing an exemplary rendering of preprinted scripts having the complimentary prescription sample means attached thereto; and

FIG. 3 is an offset view of the inventive combination prescription script and physician pad with the complimentary prescription sample means included therein in an opened position, showing an exemplary rendering of a personalized memo pad portion of the assembly from an opposite side.

FIG. 4 is an exemplary rendering of the complimentary prescription sample means of the inventive combination prescription script and physician pad with the complimentary prescription sample means included therein.

### DETAILED DESCRIPTION OF THE PREFERRED EMBODIMENTS

Reference will now be made in detail to the present preferred embodiment of the invention as illustrated in the accompanying drawings.

In its broadest aspect, the invention herein provides for a combination prescription script and memo pad assembly with complimentary sample means for prescribing prescription medications comprising a preprinted prescription pad having a plurality of preprinted prescription scripts, with each said preprinted prescription script having a front face, a complimentary sample means attached to each of the preprinted prescription scripts within the preprinted prescription pad, and a personalized memo pad having a plurality of personalized memo sheets, each with a front face, wherein the personalized memo pad is attached to the preprinted prescription pad. According to a preferred embodiment, the combination prescription script and memo pad assembly (alternatively referred to throughout collectively as “pad assembly”) provides for a combination of two pads, one of which, the preprinted prescription pad, comprises a plurality of preprinted prescription scripts for convenient and reduced-error writing of prescriptions, and the second of which, the personalized memo pad, comprises a plurality of personalized memo sheets for the convenience of prescribing doctors who wish to jot down information and directions for themselves and/or their patients. In one embodiment, the preprinted prescription pad is preprinted with a named medication and printed with a physician name and contact information that comports with individual state regulations. Attached thereto, most preferably on each individual preprinted prescription script, is a complimentary prescription sample means, while the personalized memo pad has at least the physician name and contact information such as address and phone number.

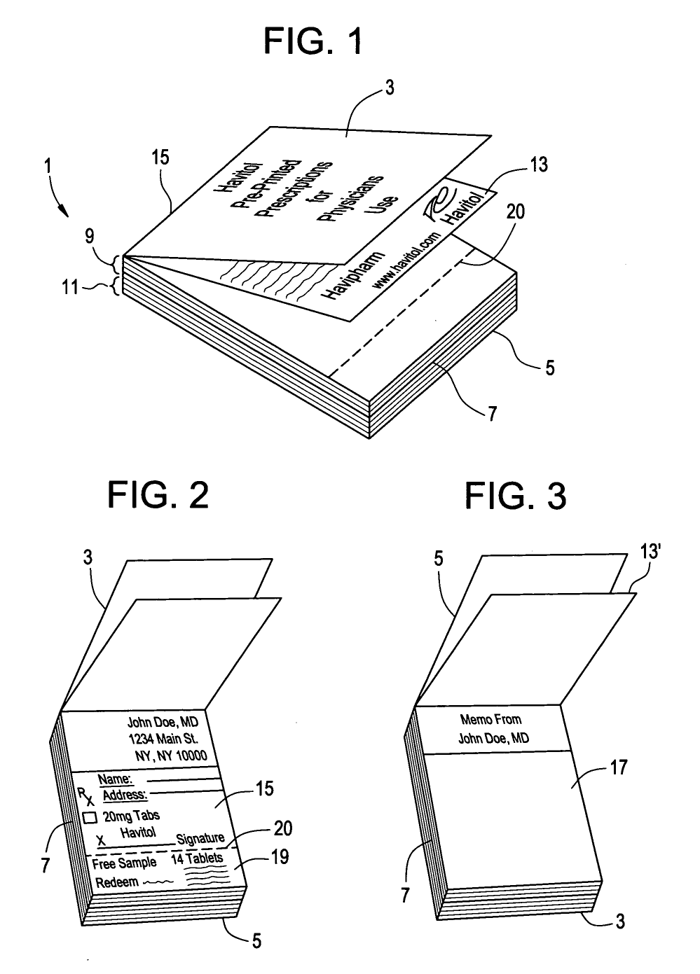

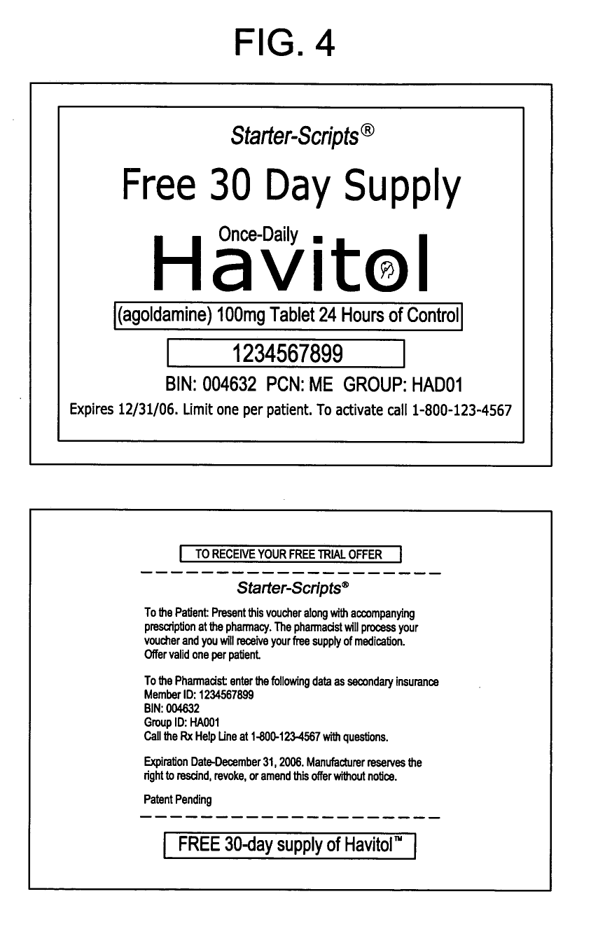

With ongoing reference to FIGS. 1, 2, 3 and 4, the combination prescription script and memo pad and complimentary prescription sample means is provided as a pad assembly 1 that comprises a preprinted prescription pad 9 and a personalized memo pad 11, having a front cover 3 identifying a target medication to which the preprinted scripts are directed, and a back cover 5 for covering the reverse side of the combination assembly. Preprinted prescription pad 9 and personalized memo pad 11 may further include information of advertising inserts 13 and/or 13′ distributed throughout the assembly. Flipping or lifting covers 3, 5 exposes the pads 9, 11 of pad assembly 1. Preferably, the covers 3, 5 will be of a substantially stiff material such as thin, printable cardboard, so as to maintain the condition of the sheets in the pad assembly 1. Markings may be printed on the covers 3, 5 to aid in the identification of the particular medication preprinted on the subject scripts. Each type of sheet preferably includes a means of detachment such as a perforation (not depicted) between each of the plurality of sheets 15, 17 respectively, and the spine 15 that binds a top margin of the totality of sheets in a conventional manner. Moreover, a divider 7 may be further provided for ease of use and rapid access to the sections.

Preprinted prescription pad 9 comprises a plurality of preprinted prescription sheets, or scripts 15. In a particular embodiment as shown, each of the plurality of prescription sheets 15 of the preprinted prescription pad 9 has a preprinted prescription on a front face of the sheet for a particular named medication. The plurality of preprinted prescription scripts 15 within a given prescription script pad 9 are preferably all identical. In some required cases, the preprinted prescription scripts 15 may include check-off boxes correlating to predetermined dosage options that can be checked off for the given prescription medicine. For example, for a given preprinted prescription script, the medication will be clearly printed on the script along with a predefined range of dosages that may be checked off, so as to avoid common errors that arise from fully handwritten prescriptions. Furthermore, the scripts will have customized identifying information of the prescriber (doctor name, address, phone number, etc.), zones for patient name and address, etc., as well as various additional features that may be printed, as needed, considering that the exact information and format of the scripts (e.g., colors, watermarks, required substitution options, and the like) will need to be further provided for on the preprinted script as required by individual state laws.

In a preferred embodiment, complimentary prescription samples means 19 may be printed directly on the front of each of the preprinted prescription scripts of a preprinted prescription pad 9 so as to be part of each preprinted prescription script 15. In a preferred embodiment however, complimentary prescription sample means 19 will be attached to the preprinted prescription scripts 15 at an extremity, such as at the bottom portion of the face of each individual preprinted prescription scripts 15 on a given preprinted prescription pad 9 in such a way so as to be formed as a detachable coupon along a perforation 20. This would permit separation of the coupon from a prescription so that a pharmacy might be able to receive reimbursement for the sample dispensing, if needed. Much like the preprinted prescription scripts themselves, the coupon embodiment of the complimentary sample means 19 may have security enhanced features such as water marks, tracking/security codes, and the like for preventing forgery and/or multiple reuse of complimentary sample means 19. Provision as such would most preferably be done so as to print a forgery-resistant, numerically sequenced coupon that a prescription recipient may readily redeem for a standard complimentary sample at a pharmacy when a script associated therewith is filled. Provision of the above offers several advantages. First, it eliminates the need for physicians to keep track of unattached samples and the need to review expiration dates, or for doctors to keep the samples stored in an accessible, climate controlled environment. Second, it provides better security by the centralizing all storage and physical dispensing of pharmaceuticals at a pharmacy, thereby eliminating or reducing problems and costs associated with theft, inadvertent loss, keeping stocks current, excess packaging, etc.

In the case of further inclusion of the personalized memo pad 11 on the pad assembly, the plurality of memo sheets 17 of the preferred embodiment will have identifying personalized information, such as “MEMO from John Doe, MD.” or the like. In one especially preferred embodiment, the personalized memo pad 11 will be attached to the preprinted prescription pad 9 in an opposite facing direction so as to facilitate access by the doctor. Overall, the configuration of the assembly, especially given the convenience of having personalized memo pad 11 attached, is designed so as to encourage usage by doctors. When structured as such, doctors who desire to jot down additional notes and directions to themselves or patients will then be inclined to use the all-in-one assembly described herein, rather than separate components.

It is to be understood that the invention is not limited to the illustrations described and shown herein, which are deemed to be more illustrative of the best modes of carrying out the invention, and which are susceptible of modification of form, size, arrangement of parts and details operation. These modifications are within the spirit and scope of the appended claims.

1. A combination prescription script and memo pad assembly with complimentary sample means for prescribing prescription medications comprising:
a preprinted prescription pad having a plurality of preprinted prescription scripts, each said preprinted prescription script having a front face;
a complimentary sample means attached to each said preprinted prescription script of said preprinted prescription pad; and
a personalized memo pad having a plurality of personalized memo sheets, each having a front face, said personalized memo pad attached to said preprinted prescription pad.

2. The pad assembly of claim 1 wherein said plurality of preprinted prescription scripts are preprinted with a named medication.

3. The pad assembly of claim 2 wherein said plurality of preprinted prescription scripts are preprinted with at least one predetermined dosage selection for said named medication.

4. The pad assembly of claim 3 wherein said complimentary sample means is a coupon redeemable for a selected complimentary prescription sample of said named medication.

5. The pad assembly of claim 4 wherein said coupon is attached to each of said plurality of preprinted prescription scripts by being printed directly on said front of said preprinted prescription script.

6. The pad assembly of claim 4 wherein said coupon is attached to each of said plurality of preprinted prescription scripts by being removably affixed along a perforation at an extremity of said preprinted prescription script.
